(19) United States
(12) Patent Application Publication
(10) Pub. No.: US 2006/0170916 A1
(43) Pub. Date: Aug. 3, 2006

(54) Method and apparatus for variable-field illumination

(76) Inventors: Thomas C. Voigt, Export, PA (US); David Tuschel, Monroeville, PA (US); Jingyun Zhang, Upper St.Clair, PA (US); Patrick J. Treado, Pittsburgh, PA (US)

Correspondence Address: DUANE MORRIS LLP, 1667 K Street, N.W., Washington, DC, 20006, US

(21) Appl. No.: 11/045,051

(22) Filed: Jan. 31, 2005

(51) Int. Cl. G01J 3/44; G01N 21/65

(52) U.S. Cl. 356/301

(57) ABSTRACT

The disclosure relates to identifying one or more regions of interest within a broader field of view of a dynamic sample using one or more optical components and illuminating photons. Once the region of interest is identified within a section of the broader field of view, chemical information in the form of Raman spectrum is obtained from the region of interest by focusing the illuminating photons or the optical components on the region of interest.

### BACKGROUND

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscopes or rigid borescopes can be employed. For very large scale objects, such as planetary objects, telescopes are appropriate image gathering optics.

Regardless of the type of optical equipment, a first step in any spectroscopic investigation is defining a suitable target. For example, the detailed diagnostics of cells require smearing cells over a surface and investigating the cells. Cellular spectroscopic diagnostic is not common but can be implemented using various analytical spectroscopic methods. Also, conventional spectroscopic imaging of such cells is performed by raster point scanning or full field imaging. The former involves raster scanning a spot focused laser point over the sample. The latter involves wide area irradiation of the sample by the laser excitation source and collecting and analyzing all of the Raman scattered light simultaneously over the entire area.

A significant step in any cytological investigation is the identification of diseased cells that may require further study. Using either of the conventional methods require first viewing a large region of cells to define regions of interest (e.g., diseased cells) and then manually aligning a data acquisition system (e.g., optical components) targeted to the region(s) of interest. However, many chemical and biological samples are dynamically changing even during the measurement period. Conventional technique provide a macroscopic field of view of the sample using a first equipment. Once one or more regions of interest has been identified, a secondary apparatus is used to study the particular regions of interest. Consequently, chemical imaging of cells for cytological investigation is cumbersome and time consuming.

The recent identification and cataloging of prominent spectral features of cells that identify diseased cells has created a need to identify a target cell quickly and capture spectral information from the target cell as quickly and accurately as possible. The conventional methods discussed above fail to provide for a simple or automated technique for aligning or defining the important cells for subsequent data acquisition. The conventional methods have several drawbacks. First, exchanging apparatus during testing may adversely affect the imaging process. Second, biological and chemical samples may undergo changes that would be completed before a second spectrometer can be activated. Finally, using multiple spectroscopic devices would make the task of identifying the region of interest difficult and time consuming. Consequently, With the need for rapid and accurate characterization of cells for cytological diagnostics, appropriate apparatus and methods are needed.

### SUMMARY OF THE DISCLOSURE

In one embodiment, the disclosure relates to a method for obtaining optical information from a sample, the method comprising the steps of: providing illuminating photons to interact with the sample to thereby produce scattered photons; obtaining a Raman image of a macro field of view of the sample from the scattered photons; selecting a region of interest from the Raman image; focusing the illuminating photons on a section of the sample corresponding to the region of interest; and obtaining optical information from the section of the sample. The method can be implemented with all wide-field Raman measurements (e.g., visible Raman, LCTF) and is possible in combination with normal visible video microscopy (imaging) and either NIR imaging, visible LCTF or fluorescence imaging.

In another embodiment, the disclosure is directed to a system for obtaining optical information from a sample. The system includes a photon source for providing illuminating photons to interact with the sample to thereby produce scattered photons; an imaging subsystem capable of obtaining a Raman image of a macro field of view of the sample from the scattered photons; means for selecting a region of interest from the Raman image; a focusing subsystem for focusing the illuminating photons on a section of the sample corresponding to the region of interest; and the imaging subsystem further capable of obtaining optical information from the section of the sample.

In still another embodiment, the disclosure relates to a machine-readable medium having stored thereon a plurality of executable instructions for operating a processor to obtain optical information from a sample, the plurality of instructions comprising instructions to provide illuminating photons to interact with the sample to produce scattered photons; obtain a Raman image of a macro field of view of the sample from the scattered photons; select a region of interest from the Raman image; focus the illuminating photons on a section of the sample corresponding to the region of interest; and obtain optical information from the section of the sample.

### BRIEF DESCRIPTION OF THE DRAWINGS

FIG. 1 schematically illustrates obtaining a first field of view of the sample according to one embodiment of the disclosure; and

FIG. 2 schematically illustrates obtaining a second field of view of the sample according to one embodiment of the disclosure.

### DETAILED DESCRIPTION

The principles disclosed herein generally relates to dynamic molecular imaging. More particularly, the principles disclosed herein provide a novel and integrated approach to locating regions of interest in a sample, identifying the target cell, optimizing the illumination on the target cell and acquiring high quality spectral image of the region of interest. These steps improve efficiency and quality of data and removes subjective operator error from the process. Moreover, these steps remove image signal noise caused by the thermal drift, equipment vibrations and other time-dependent interferences associated with the point scanning method.

In one embodiment, the disclosure enables using a single apparatus to view and record various regions of interest within a sample. By providing means for continuous monitoring of the sample this and other embodiment are particularly advantageous when the sample under study is a chemical or a biological assay. Dynamic measurements enable monitoring and recoding spectral images of moving samples (e.g., continuous flow/stream of fluid) when the movement is within the region of interest. The region of interest can be fixed (static) or variable (dynamic).

In one embodiment, the disclosure relates to a method for obtaining optical information from a sample by illuminating the sample with photons to interact with the sample and produce activated photons. The illumining photons can optionally have wavelengths in the NIR, VIS, Fluorescence or Raman bands. The illuminating photons can be provided from a source above or below the sample. The interacted photons include, among others, Raman scattered photons, emissive photons or absorption photons. The interacted photons can be directed to an appropriate imaging device to obtain an image of the sample in the macro field of view. Conventional imaging devices include an optical filter and a charged couple device. The optical filter may include a liquid crystal tunable filter (LCTF), accousto-optic tunable filter (AOTF) or the like.

Once an image (e.g., a Raman image) is obtained from a macro field of view, a region of interest within the macro field of view can be identified. Different criteria can be used for identifying the region for interest. For example, the region of interest can be identified based on the intensity of wavelength of the interacted photons at a region. Moreover, the region of interest may include several sites and need not be limited to only one site. Once the region(s) of interest is identified, the illuminating photons can be focused on a section of the sample corresponding to the region of interest to obtain optical information from the region by, for example, refocusing the laser beam. In one embodiment, the refocusing of the laser beam is implemented without changing the optical or imaging magnification. This method is particularly advantageous as it is faster than changing the objective lens and it enables higher power density over the target cell and thereby higher quality in shorter time.

The step of obtaining a Raman image of the macro field of view and the step of obtaining optical information from a section of the sample containing the region of interest can be accomplished by using an optical system with a set of optical lenses. The optical information may include a chemical or a Raman spectral image. The optical lenses can be an optical train or a microscope objective. In one embodiment, the optical system includes a plurality of interchangeable lenses received by a stationary structure that enables interchanging the plurality of lenses without disturbing the sample.

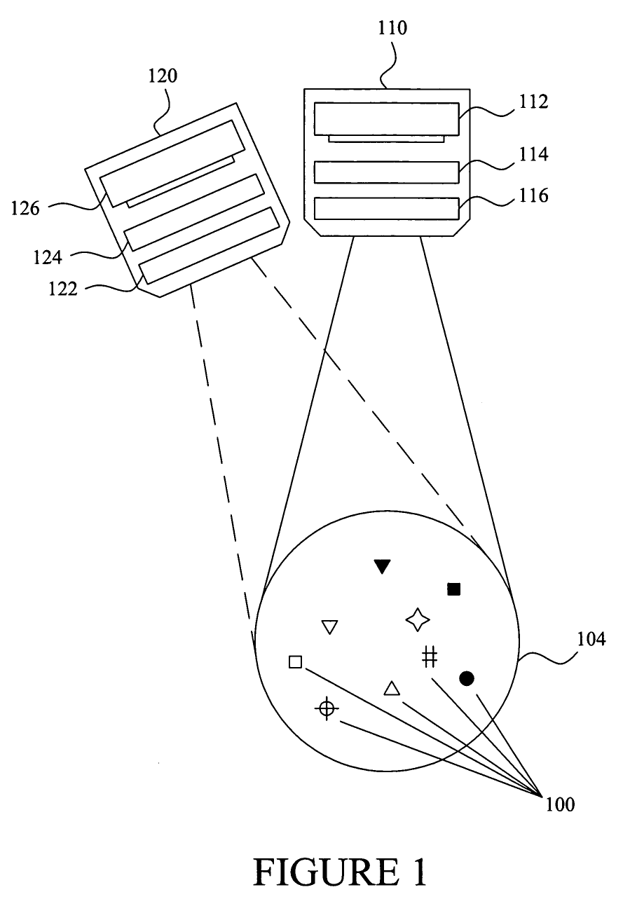

FIG. 1 schematically illustrates obtaining a first field of view of the sample according to one embodiment of the disclosure. Specifically, FIG. 1 shows a source of illumination photons which are typically produced by a laser or filtered source of nearly monochromatic light (e.g., FWHM of about 0.25 nm) which can be focused and/or polarization-filtered to illuminate a sample. The sample contains various objects 100 or regions in the field of illumination. The field of illumination 104 is a macro field of view. The field of illumination 104 produces Raman scattered light which can be collected by Raman photon detector 120. Here, the field of collection for the Raman scattered light is shown and is typically about the size of field of view 104 and illumination shown in FIG. 1.

In FIG. 1 illumination source 110 is a source of photons and may include illumination source 112, optical control device 114 and polarization control device 116. Optical control device 114 controls one or more lenses to focus the illumination photons as needed. The polarization control device 116 allows for changes to the photon polarization. The optical control device 114 and the polarization control device 116 may be selected such that a macro field of view 104 illuminates regions 100. Similarly, Raman detector 120 may include polarization controller 122, optical control device 124 and Raman detector 126. Optical control device 124 and polarization controller 126 operate similar to devices 114 and 116 of illumination source 110. The Raman detector 126 may further comprise an electronically tunable imaging device and a photon detector such as Liquid Crystal Tunable Filter (LCTF) in combination with a charged coupled devices (CCD).

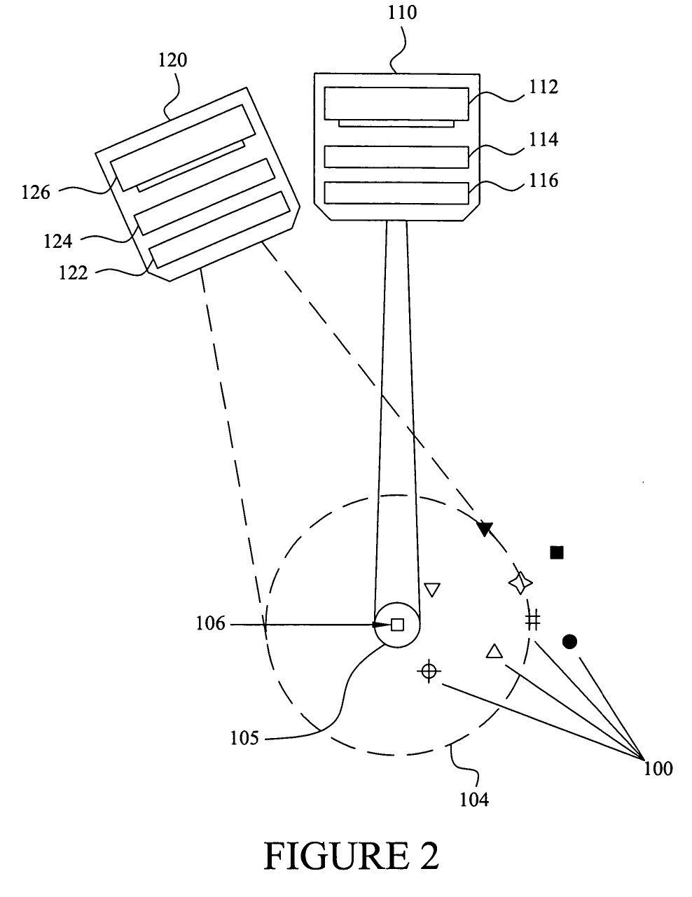

In one embodiment, after examination of the entire field of view 104 the sample can be repositioned by various means to have one of the objects of interest 106 coincide with the optical illumination axis as shown in FIG. 2. Here, the macro field of view may remain 104 the same as in the previous step. However, the illumination area or spot size 105 is controlled by the illumination optics to contain primarily the object or region of interest 106 for detailed examination. Raman Detector 120 now collects photons emitted from the illuminated region 105 which includes object 106. Changes in the focusing of the Raman Photon detector in FIG. 2 to view only 106 is possible but not shown. Such changes in the Raman Photon detector to focus on the region of interest 106 may be advantageous under some circumstances, but generally not necessary. The polarization of the illuminating photons can be changed for any particular object or sample orientation as needed using the polarization control 116 (see FIG. 1). The polarization of the Raman photons can similarly be reoriented by a polarization controller 122 as required.

The disclosure also relates to a system for obtaining optical information from a sample. In one embodiment, the includes a photon source for providing illuminating photons to interact with the sample. The interacted photons may include wavelength in the emissive, absorption and Raman bands. The system can also include an imaging subsystem, which using the scattered photons, can obtain a Raman image of a macro field of view of the sample. Using pre-defined threshold parameters, the system can select one or more regions of interest from the Raman image. A secondary optical system can be used to focus illuminating photons on a portion of the sample corresponding to the region of interest.

A system according to one embodiment of the disclosure includes only one set of optical lenses. Accordingly, one set of optical lenses is used to study the macro field of view as well as to obtain the Raman image of the region of interest. In another embodiment, the imaging system may include distinct optical components for obtaining the macro field of view as well as for detecting a Raman image of the region of interest.

The principles of the disclosure can also be implemented by using a controller communicating with a processor programmed with instructions to obtain a Raman image of a region of interest from a macro field of view of a sample. Thus, in one embodiment, the disclosure concerns a machine-readable medium having stored thereon a plurality of executable instructions for operating a processor to obtain optical information from a sample. The plurality of instructions include instructions to (i) provide illuminating photons to interact with the sample to produce scattered photons; (ii) obtain a Raman image of a macro field of view of the sample from the scattered photons; (iii) select a region of interest from the Raman image; (iv) focus the illuminating photons on a section of the sample corresponding to the region of interest; and (v) obtain optical information such as a Raman image from the section of the sample.

The machine readable medium may implement the steps of obtaining a Raman image of a macro field of view of the sample and obtaining optical information from the section of the sample by using an optical system with one set of optical lenses. In an alternative embodiment, secondary optical lenses can be used for obtaining optical information from the region of interest.

The embodiments disclosed herein are exemplary and non-limiting. While the principles of the disclosure have been disclosed in relation to specific exemplary embodiments, it is noted that the principles of the invention are not limited thereto and include all modification and variation to the specific embodiments disclosed herein.

What is claimed is:

1. A method for obtaining optical information from a sample, the method comprising the steps of:
providing illuminating photons to interact with the sample to thereby produce scattered photons;
obtaining a Raman image of a macro field of view of the sample from the scattered photons;
selecting a region of interest from the Raman image;
focusing the illuminating photons on a section of the sample corresponding to the region of interest; and
obtaining optical information from the section of the sample.

2. The method of claim 1 wherein the optical information is a chemical image.

3. The method of claim 1 wherein the optical information is a Raman image.

4. The method of claim 1 wherein the step of obtaining a Raman image of a macro field of view of the sample and the step of obtaining optical information from the section of the sample are each accomplished by use of an optical system with one set of optical lenses.

5. The method of claim 1 wherein the optical information consists of at least one Raman spectrum.

6. The method of claim 1 further comprising the step of controlling the polarization of illuminating photons prior to providing illuminating photons to interact with the sample.

7. The method of claim 1 wherein the step of selecting a region of interest further comprises moving or rotating the sample in a direction to optimize illumination.

8. A system for obtaining optical information from a sample, the system comprising:
a photon source for providing illuminating photons to interact with the sample to thereby produce scattered photons;
an imaging subsystem capable of obtaining a Raman image of a macro field of view of the sample from the scattered photons;
means for selecting a region of interest from the Raman image;
a focusing subsystem for focusing the illuminating photons on a section of the sample corresponding to the region of interest; and
the imaging subsystem further capable of obtaining optical information from the section of the sample.

9. The system of claim 8 wherein the imaging subsystem is further capable of obtaining a chemical image from the section of the sample.

10. The system of claim 8 wherein the imaging subsystem is further capable of obtaining a Raman image from the section of the sample.

11. The system of claim 8 wherein the imaging subsystem contains only one set of optical lenses.

12. The system of claim 8 wherein the photons source further comprises at least one of polarization controller and control optics.

13. The system of claim 8 wherein the optical information consists of at least one Raman spectrum.

14. The system of claim 8 wherein at least one of photon source or the imaging subsystem further comprises a polarizer.

15. A machine-readable medium having stored thereon a plurality of executable instructions for operating a processor to obtain optical information from a sample, the plurality of instructions comprising instructions to:
provide illuminating photons to interact with the sample to produce scattered photons;
obtain a Raman image of a macro field of view of the sample from the scattered photons;
select a region of interest from the Raman image;
focus the illuminating photons on a section of the sample corresponding to the region of interest; and
obtain optical information from the section of the sample.

16. The machine-readable medium of claim 15 wherein the optical information is a chemical image.

17. The machine-readable medium of claim 15 wherein the optical information is a Raman image.

18. The machine-readable medium of claim 15 wherein the step of obtaining a Raman image of a macro field of view of the sample and the step of obtaining optical information from the section of the sample are each accomplished by use of an optical system with one set of optical lenses.

19. The machine-readable medium of claim 15 wherein the optical information consists of at least one Raman spectrum.

20. The machine-readable medium of claim 15 wherein the step of optical information from the section of the sample further comprises moving or rotating the sample.
